(19) United States
(12) Patent Application Publication
(10) Pub. No.: US 2026/0162131 A1
(43) Pub. Date: Jun. 11, 2026

(54) METHOD AND SYSTEM FOR PROCESSING ANALYTICAL QUERIES TO EXTRACT BUSINESS INSIGHTS AND SUPPORT DECISION-MAKING FROM ENTERPRISE DATA

(71) Applicant: LTI Mindtree Ltd, Mumbai (IN)

(72) Inventors: Shivanand Pawar, Mumbai (IN); Tushar Madheshia, Mumbai (IN); Ranganath Ramkrishna, Mumbai (IN); Saurabh Jain, Mumbai (IN); Pradeep T, Mumbai (IN)

(21) Appl. No.: 19/078,678

(22) Filed: Mar. 13, 2025

(30) Foreign Application Priority Data
Dec. 5, 2024 (IN) 202421096085

(51) Int. Cl. G06Q 30/0201; G06N 20/00; G06Q 10/0633

(52) U.S. Cl. CPC G06Q 30/0201; G06N 20/00; G06Q 10/0633

(57) ABSTRACT

Disclosed is a method and system for processing analytical queries, using a multi-agent framework, to extract business insights and support decision-making from enterprise data. Worker agents execute data processing and analysis operations on enterprise data, which include a data engineer agent that extracts and transforms enterprise data and a data scientist agent that applies analytical models to transformed data, and a data analyst agent that generates analytical insights. An orchestration engine receives an analytical query from a user and analyzes it to determine the data processing and analysis operations. A computational workflow is generated comprising a sequence of the one or more data processing and analysis operations that are assigned to the worker agents based on specific operation requirements and are sequentially executed according to workflow dependencies. Business insights generated from the execution are presented to the user.

### FIELD

Various embodiments of the present disclosure generally relates to processing analytical queries. More particularly, the disclosure relates to a method and system for processing analytical queries, using a multi-agent framework, to extract business insights and support decision-making from enterprise data.

### BACKGROUND

Organizations today encounter significant challenges in making data-driven decisions due to limitations in both data accessibility and analytical capabilities. Decision-makers often struggle with fragmented data sources, inconsistent formats, and delayed data acquisition, leading to decisions based on incomplete or outdated information. Additionally, existing analytical systems either prove too complex for business users or lack the computational power to process large-scale enterprise data effectively, creating a gap between data availability and actionable insights.

In addition to data-related challenges, many decision-makers face skill gaps that hinder their ability to perform detailed data analysis independently. Without sufficient expertise in data analytics, they often rely heavily on technical teams to process and interpret the information. The dependence not only slows down the decision-making process but also creates bottlenecks, as technical teams may already be burdened with other priorities. Furthermore, even with data-driven insights, personal biases can influence how decision-makers interpret information or prioritize outcomes, leading to subjective conclusions that may not align with the organization's best interests.

Another critical challenge faced by organizations is the complexity and sometimes conflicting nature of the data available for decision-making. Decision-makers often encounter data from diverse sources, formats, and contexts, which can make interpretation difficult and prone to errors. Additionally, the lack of standardized decision-making processes within organizations leads to inconsistent approaches, resulting in unpredictable outcomes and reduced confidence in decision strategies. Furthermore, decision-makers often fail to fully comprehend the risks associated with their choices, either due to inadequate risk modeling or limited visibility into potential long-term impacts. The uncertainty is compounded by a pervasive fear of failure, which can paralyze the decision-making process, causing delays or, in extreme cases, preventing critical decisions from being made altogether.

Addressing these challenges requires advancement in four critical areas. First, organizations need systems that ensure data accuracy and consistency across sources. Second, they require advanced analytical tools that can process complex enterprise data efficiently. Third, these tools must provide user-friendly interfaces that enable business users to perform sophisticated analysis independently. Finally, organizations need standardized processes that ensure consistent analytical approaches across different business scenarios.

### SUMMARY

A method and system for processing analytical queries, using a multi-agent framework, to extract business insights and support decision-making from enterprise data is disclosed. Each worker agent of a plurality of worker agents executes data processing and analysis operations on enterprise data. The plurality of worker agents include a data engineer agent that extracts and transforms enterprise data and a data scientist agent that applies analytical models to transformed data, and a data analyst agent that generates analytical insights. An orchestration engine of the framework receives an analytical query from a user and analyzes it to determine the data processing and analysis operations. A computational workflow is generated that includes a sequence of the one or more data processing and analysis operations that are assigned to the worker agents based on specific operation requirements and are sequentially executed according to workflow dependencies. Business insights generated from the execution are presented to the user.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 is a diagram that illustrates an exemplary environment within which various embodiments of the present disclosure may function.

FIG. 2 is a diagram that illustrates the system for processing analytical queries to extract business insights and support decision-making from enterprise data, in accordance with an embodiment of the disclosure.

FIG. 3 is an exemplary diagram that illustrates the multi-agent framework of the system for processing the analytical queries to generate business insights and support decision-making, in accordance with an embodiment of the disclosure.

FIG. 4 is a diagram that illustrates a flow chart for a method for processing analytical queries to extract business insights and support decision-making from enterprise data, in accordance with an embodiment of the disclosure.

### DESCRIPTION

Pursuant to various embodiments, the method and system for processing analytical queries, using a multi-agent framework, to extract business insights from enterprise data is disclosed. Each worker agent of a plurality of worker agents executes data processing and analysis operations on enterprise data. The plurality of worker agents include a data engineer agent that extracts and transforms enterprise data and a data scientist agent that applies analytical models to transformed data, and a data analyst agent that generates analytical insights. An orchestration engine of the framework receives an analytical query from a user and analyzes it to determine the data processing and analysis operations. A computational workflow is generated that includes a sequence of the one or more data processing and analysis operations that are assigned to the worker agents based on specific operation requirements and are sequentially executed according to workflow dependencies. Business insights generated from the execution are presented to the user.

In one or more embodiments, the analytical queries refer to a structured or semi-structured request made by the user to derive insights or answers from enterprise data. The analytical queries are typically used to extract, analyze, and interpret data to support decision-making processes. For instance, the analytical queries may encompass a wide range of operations, including, but not limited to, data aggregation, pattern recognition, trend analysis, predictive modeling, and anomaly detection.

In one or more embodiments, the multi-agent framework for processing analytical queries may be designed as a modular and scalable system, including specialized worker agents. Each component of the multi-agent framework operates collaboratively to transform user queries into actionable business insights.

In one or more embodiments, business insights are actionable conclusions or understandings derived from analyzing data, aimed at improving decision-making and driving strategic goals within an organization. Business insights go beyond presenting raw data or basic metrics by interpreting and contextualizing information to reveal trends, patterns, correlations, or anomalies that directly impact business outcomes. Business insights help organizations answer critical questions, identify opportunities, mitigate risks, and refine operational strategies. In some non-limiting embodiments, business insights can be such as, but not limited to, customer behavior insights, operational efficiency insights, market trends insights, financial performance insights, and employee engagement insights.

In one or more embodiments, enterprise data refers to the vast array of information generated, collected, and utilized across an organization. The data encompasses all the records and information that support daily business operations, decision-making, strategic planning, and regulatory compliance within an enterprise. It includes both structured and unstructured data, gathered from a wide variety of internal and external sources, and often spans multiple departments, systems, and platforms. In some non-limiting embodiments, enterprise data may include, but not limited to, transactional data, operational data, customer data, financial data, employee data, unstructured data, and metadata.

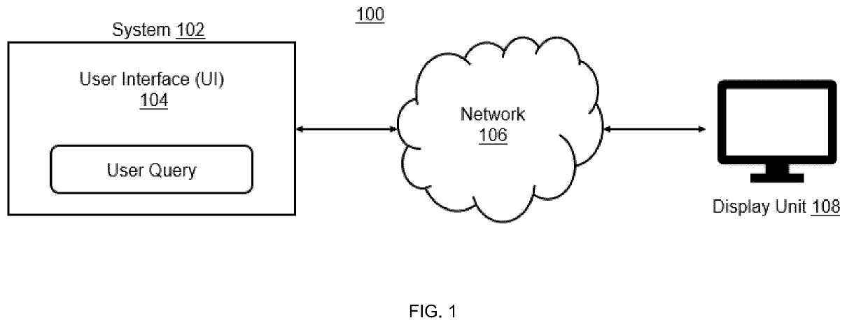

FIG. 1 is a diagram that illustrates an exemplary environment 100 within which various embodiments of the present disclosure may function. Referring to FIG. 1, the environment 100 includes a system 102, a user interface (UI) 104, a network 106, and a display unit 108.

The system 102 processes analytical queries to extract business insights through an orchestration layer that integrates a multi-agent framework. The multi-agent framework leverages a combination of advanced technologies, including, but not limited to, a Large Language Model (LLM), multiple machine learning (ML) models, and a robust semantic data model. The ML models may either be proprietary to the system's 102 provider (e.g., FDC) or contributed by the customer, ensuring flexibility and adaptability to different enterprise needs.

In one or more embodiments, the orchestration layer may be configured to ensure seamless interaction between these components, enabling the system 102 to handle complex analytical workflows effectively. The LLM facilitates the natural language understanding of analytical queries, allowing decision-makers to express their data needs intuitively. The semantic data model may be configured to organize enterprise data with meaningful relationships and contextual understanding, ensuring that the insights generated are accurate, relevant, and actionable.

The UI 104 of the system 102 refers to an interactive platform where the user can enter an analytical query. The UI 104 is also designed to receive inputs of various types, allowing for flexible and adaptable user interactions.

In one or more embodiments, the UI 104 refers to a visual interface that enables the user to interact with electronic devices through graphical elements, such as icons, buttons, and windows. The intuitive design simplifies the user experience by allowing individuals to navigate and execute tasks more easily.

In some non-limiting embodiments, the UI 104 is designed to receive a diverse range of input types and forms, accommodating various user preferences and operational needs such as keyboard and mouse interactions, as well as modalities like touch, voice recognition, and natural language processing.

The network 106 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other network.

In one or more embodiments, the network 106 facilitates connection between the system 102 and the display unit 108 via one or more communication channels.

In one or more embodiments, the display unit 108 may be configured to present the generated insights to the user in a visually intuitive and interactive manner. The display unit 108 can include, but is not limited to, devices such as, interactive dashboards, touchscreen displays, projection systems, and wearable displays.

In some non-limiting embodiments, the display unit 108 can be located within an enterprise environment or at any other remote location, providing flexibility in accessing and presenting insights to users. For instance, in an enterprise setting, the display unit 108 could be integrated into centralized workstations or conference room systems, facilitating collaborative decision-making among teams. Conversely, in remote locations, the display unit 108 could be accessed via portable devices such as laptops, tablets, or smartphones, ensuring seamless connectivity and uninterrupted workflow regardless of the user's physical location.

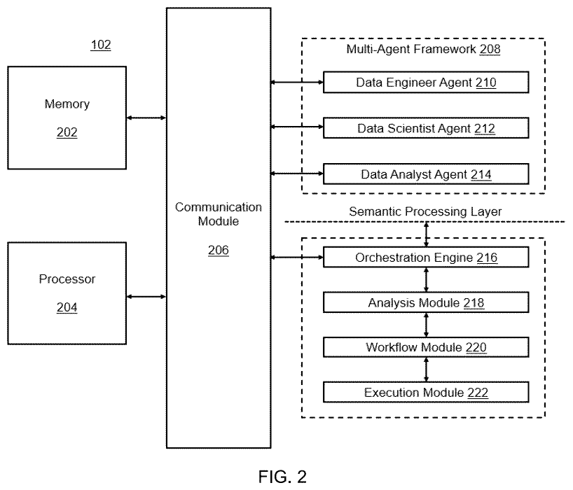

FIG. 2 is a diagram that illustrates the system 102 for processing analytical queries to extract business insights and support decision-making from enterprise data, in accordance with an embodiment of the disclosure. Referring to FIG. 2, the system 102 includes a memory 202, a processor 204, a communication module 206, a multi-agent framework 208 comprising a data engineer agent 210, a data scientist agent 212, a data analyst agent 214, an orchestration engine 216, an analysis module 218, a workflow module 220, and an execution module 222.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 102 in accordance with various aspects of the present disclosure. The processor 204 may be further configured to communicate with various modules of the system 102 via the communication module 206.

The multi-agent framework 208 of the system 102 is designed as a modular and scalable system that includes multiple specialized worker agents, which can be implemented as artificial intelligence agents, such as, but not limited to, the data engineer agent 210, the data scientist agent 212, and the data analyst agent 214.

In one or more embodiments, the multi-agent framework 208 includes an extensible architecture configured to accommodate integration of additional worker agents beyond the aforementioned agents. The extensible architecture enables dynamic incorporation of specialized agents such as, but not limited to, a decision maker agent configured to provide automated decision support functionality, an unstructured data processing agent configured to process and analyze unstructured data sources, and other domain-specific agents configured to execute specialized analytical operations. The extensible architecture of the multi-agent framework 208 facilitates adaptation to evolving analytical requirements while maintaining operational consistency of the core framework functionality.

In one or more embodiments, the multi-agent framework 208 incorporates a semantic processing layer that operates in conjunction with the orchestration engine 216. The semantic processing layer contains domain-specific semantic data models defining relationships between enterprise entities for business insight extraction. The semantic processing layer houses domain-specific semantic data models, which serve as structured representations of relationships and hierarchies between various enterprise entities. The semantic data models encapsulate the contextual meaning and interdependencies of enterprise data elements, enabling the orchestration engine 216 to interpret and analyze data in ways that align with the specific needs of the business domain. For example, in a retail domain, the semantic data model may define relationships between products, customers, suppliers, and sales regions, whereas, in healthcare, it might map connections between patients, treatments, providers, and outcomes.

In one or more embodiments, the semantic processing layer may be configured to be integrated with the orchestration engine 216 to support end-to-end query processing. When the orchestration engine 216 receives an analytical query, it interacts with the semantic processing layer to interpret the query in the context of the defined domain. The semantic data models guide the orchestration engine 216 in determining relevant data sources, optimizing data extraction, and refining analysis operations.

In one or more embodiments, the semantic processing layer includes trained machine learning (ML) models for categorizing enterprise data, prediction models for forecasting business metrics, clustering models for pattern identification, and natural language processing models for query interpretation.

In an exemplary embodiment, the ML models are trained to classify enterprise data into predefined categories or groups based on its content, structure, or metadata. For example, financial data can be categorized into revenue, expenses, and budgets, while customer-related data can be grouped by demographics, behavior, or preferences.

In an exemplary embodiment, the semantic processing layer includes forecasting models that predict key business metrics based on historical data and current trends. For instance, the forecasting models might forecast future sales, inventory requirements, or customer churn rates. By analyzing time-series data, identifying correlations, and applying statistical techniques, the forecasting models provide forward-looking insights that help organizations anticipate challenges and capitalize on opportunities.

In an exemplary embodiment, clustering models are employed to identify patterns and group similar data points together without predefined labels. The clustering models are particularly useful for segmenting customers into similar behavioral groups, detecting anomalies in operational data, or uncovering hidden trends in business processes. By finding natural groupings within data, the clustering models enable decision-makers to understand complex relationships and tailor strategies to specific clusters.

In one or more embodiments, the semantic processing layer integrates NLP models for interpreting user-submitted analytical queries expressed in natural language. The NLP models parse the queries to understand the user's intent, identify relevant keywords, and map the queries to the underlying enterprise data structures and relationships. For example, when a user asks, “What were the top-performing products last quarter in Region A?”, the NLP model interprets this query, identifies key parameters (e.g., “top-performing products,” “last quarter,” “Region A”), and guides the orchestration engine 216 in executing the appropriate workflow.

In one or more embodiments, In one or more embodiments, the orchestration engine 216 may be configured to utilize artificial intelligence and the semantic processing layer to perform tasks such as, but not limited to, interpret the analytical query, identify relevant data sources and relationships, and select appropriate machine learning models for analysis.

In one or more embodiments, when an analytical query is received, the orchestration engine 216 relies on the semantic processing layer to interpret the query accurately. Using natural language processing (NLP) models and domain-specific semantic data models, the query is broken down into its key components, such as intent, entities, and metrics. For example, if the query is “Show the monthly revenue trends for Region A,” the semantic layer identifies the focus on “monthly revenue trends” and contextualizes it with “Region A” to guide subsequent operations.

In one or more embodiments, the semantic processing layer, with its domain-specific data models, enables the orchestration engine 216 to determine which data sources contain the information needed to fulfill the query. It maps relationships between enterprise entities, such as linking sales data to regional performance metrics or customer interactions to purchasing trends. By understanding these relationships, the engine ensures that data extraction is targeted and efficient, avoiding irrelevant or redundant information.

In one or more embodiments, based on the nature of the query and the contextual insights provided by the semantic layer, the orchestration engine 216 may be configured to dynamically select suitable machine learning models for analysis. For instance, if the query requires forecasting, prediction models are chosen, whereas if it involves segmentation, clustering models are employed or else if a query demands anomaly detection, relevant diagnostic models are utilized. The semantic processing layer ensures that the models selected align with the domain-specific context and data structure, optimizing the accuracy and relevance of the analysis.

The data engineer agent 210 of the multi-agent framework 208 may comprise suitable logic, code, and/or interface that is configured to extract data from one or more enterprise data sources, and perform data transformation operations to standardize data format. The data engineer agent 210 then validates data quality based on predefined rules and maintains data lineage throughout processing operations.

In one or more embodiments, the data engineer agent 210 may be configured to connect to one or more enterprise data sources, which may include relational databases, data warehouses, cloud storage systems, IoT device feeds, or external APIs. By utilizing optimized interfaces and protocols, the data engineer agent 210 efficiently extracts data regardless of its source, structure, or storage format, which ensures that all relevant data required for the analytical query is collected. For instance, it might extract customer transaction data from an SQL database and complementary behavioral data from a NoSQL repository.

After extraction, the data engineer agent 210 may be configured to perform transformation operations to standardize the data into a unified format suitable for subsequent processing. This may involve tasks such as, but not limited to, schema alignment, data type conversions, normalization, aggregation, or the resolution of missing and inconsistent values. By standardizing the data, the data engineer agent 210 ensures compatibility with analytical workflows and enhances the accuracy of downstream processing by the data scientist agent 212 or the data analyst agent 214.

In one or more embodiments, to maintain the integrity of the analysis, the data engineer agent 210 may be configured to validate the extracted and transformed data against predefined quality rules. These rules may include, but not limited to, checks for completeness, consistency, accuracy, and compliance with regulatory standards. For example, the data engineer agent 210 may be configured to flag anomalies such as duplicate entries, out-of-range values, or missing key attributes in a dataset. Such validations prevent errors or biases from propagating into analytical operations.

In one or more embodiments, the data engineer agent 210 may be configured to track data lineage, documenting the origin, transformations, and flow of data, which includes recording details of source systems, applied transformation logic, and the sequence of operations performed.

The data scientist agent 212 of the multi-agent framework 208 may comprise suitable logic, code, and/or interface that is configured to extract and transform enterprise data. The data scientist agent 212 may be configured to select appropriate analytical models based on data characteristics and apply the selected models to the transformed data. The data scientist agent 212 may be configured to tune model parameters for optimal performance and interpret outputs for further analysis.

In one or more embodiments, the data scientist agent 212 may be configured to interface seamlessly with the data engineer agent 210 to extract transformed enterprise data that is already standardized and validated. In cases where additional refinement is required, the data scientist agent 212 may be configured to further preprocess the data, performing tasks such as feature extraction, scaling, encoding categorical variables, or inputting missing values.

In one or more embodiments, based on the characteristics of the data and the objectives of the analytical query, the data scientist agent 212 may be configured to selects the most suitable analytical models, which may include regression for trend analysis, classification for predicting categories, clustering for segment discovery, or deep learning models for handling large-scale unstructured data. The selection process considers factors such as data size, distribution, and domain-specific requirements, ensuring alignment with the problem at hand. For instance, in a query involving customer segmentation, the agent may choose a clustering algorithm like k-means or DBSCAN.

In one or more embodiments, the data scientist agent 212 may be configured to tune the selected model's parameters, which involves testing different configurations through techniques such as grid search, random search, or automated hyperparameter optimization methods. For example, in a random forest model, the data scientist agent 212 might fine-tune the number of trees, maximum depth, and feature subsets to achieve the best predictive accuracy.

After selecting and fine-tuning the models, the data scientist agent 212 may be configured to apply them to the transformed data to generate outputs. The outputs could be predictions, trends, anomaly detections, or pattern identifications, depending on the query's requirements. For example, if the task is sales forecasting, the data scientist agent 212 applies a time-series model and produces predictions for future sales figures based on historical data.

In one or more embodiments, beyond generating raw outputs, the data scientist agent 212 may be configured to interpret the results to make them meaningful for further analysis or decision-making. This may involve explaining model behavior, identifying significant patterns, or highlighting potential anomalies. The data scientist agent 212 may be configured to ensure that the outputs are understandable and contextually relevant, aiding the data analyst agent 214 or end-user in deriving actionable business insights.

The data analyst agent 214 of the multi-agent framework 208 may comprise suitable logic, code, and/or interface that is configured to generate analytical insights. The data analyst agent 214 may be configured to perform statistical analysis on processed data and generates interactive data visualizations. The data analyst agent 214 then identifies key patterns and trends and creates comprehensive analytical reports.

In one or more embodiments, the data analyst agent 214 may be configured to extract meaningful insights from the processed data by applying a combination of statistical and inferential analysis techniques to understand the relationships, distributions, and dynamics within the data. For example, the data analyst agent 214 may calculate metrics like growth rates, correlations, or variance to highlight critical business indicators.

In one or more embodiments, the data analyst agent 214 may be configured to employ statistical methods to validate and interpret processed data. Techniques such as hypothesis testing, regression analysis, and time-series analysis are used to draw conclusions and quantify relationships between variables. For instance, the data analyst agent 214 might perform a trend analysis to identify seasonal patterns in sales data or a regression analysis to understand the factors driving customer retention.

In one or more embodiments, to make the insights accessible and engaging, the data analyst agent 214 may be configured to generate dynamic, interactive visualizations such as bar charts, scatter plots, heat maps, and dashboards. The visualizations are tailored to the user's requirements and enable decision-makers to explore the data in a visual format. For example, a heat map could reveal regional sales performance, while a time-series graph might illustrate revenue growth over quarters.

In one or more embodiments, the data analyst agent 214 may be configured to identify and highlight key patterns, trends, and anomalies that emerge from the analysis. This includes recognizing upward or downward trends, clustering behaviors among customer groups, or flagging deviations from expected performance. The insights enable businesses to proactively address issues or capitalize on opportunities.

In one or more embodiments, the data analyst agent 214 may be configured to compile findings into structured, detailed reports that provide a narrative around the data. These reports often include summaries of key metrics, explanations of observed trends, supporting visualizations, and actionable recommendations. For example, a report might summarize quarterly sales performance, highlight the most and least profitable regions, and suggest strategies for improving underperforming areas.

In one or more embodiments, each type of worker agent can appear multiple times within a workflow in two ways: through multiple concurrent instances for parallel processing, and through sequential invocation at different steps in the workflow sequence. Each worker agent type, including the data engineer agent 210, the data scientist agent 212, and the data analyst agent 214, can be called upon repeatedly as needed based on the requirements of different operations in the workflow sequence. For example, a data scientist agent 212 might first be invoked to apply a classification model on initial data, and later in the same workflow sequence, be called again to perform prediction analysis on the intermediate results. Similarly, multiple instances of the data engineer agent 210 can be created to handle parallel data extraction from different enterprise data sources when concurrent processing is required.

The orchestration engine 216 may be configured to manage both the sequential reuse of worker agents and concurrent execution of multiple instances. In sequential operations, a worker agent type is invoked at different points in the workflow as required by the sequence of operations, similar to function calls in programming. For instance, within a single workflow, a data scientist agent 212 might be called first for data classification, then the data engineer agent 210 for data transformation, followed by another invocation of the data scientist agent 212 for trend analysis. Simultaneously, when parallel processing is beneficial, multiple instances of the same agent type can execute different operations concurrently. This flexible approach allows the system 102 to optimize both sequential processing through agent reuse and parallel processing through multiple instances, depending on the workflow requirements and operation dependencies.

In one or more embodiments, the system 102 may be configured to assign specific operations to each worker agent based on operation requirements determined by the orchestration engine 216. Whether invoked sequentially at different points in the workflow or instantiated as parallel instances, each worker agent performs operations according to its configured capabilities and the specific requirements of that workflow step. For example, in a complex analytical workflow, one instance of the data scientist agent 212 might apply a regression model to forecast sales, while later in the sequence, another invocation of the data scientist agent 212 might apply a clustering algorithm to segment customer data. The system 102 thus dynamically adapts to both the sequence requirements and complexity of analytical queries.

In one or more embodiments, this flexible approach to worker agent utilization—combining sequential invocation and parallel instantiation—enables the system 102 to optimize workflow execution. When dependencies require sequential processing, the same type of worker agent can be called multiple times at different steps. When operations can be performed independently, multiple instances of a worker agent can execute concurrently. This dual capability allows the system 102 to both maintain proper operation sequence and maximize parallel processing where possible, effectively managing computational resources based on workflow requirements.

The orchestration engine 216 may comprise suitable logic, code, and/or interface that may be configured to receive an analytical query from the user via the UI 104. The orchestration engine 216 is designed to handle queries in various formats, including natural language expressions, structured SQL-like syntax, or selections from predefined query templates, making it flexible to different user preferences and query complexities. For example, users can submit queries ranging from high-level business questions like “What are the top-performing products in the last quarter?” to more specific analytical requests such as “Forecast sales for the next six months based on historical trends.” This flexibility in query acceptance enables business users to interact with the system 102 using their preferred mode of expression while ensuring the queries can be systematically processed.

In one or more embodiments, the orchestration engine 216 employs the analysis module 218, which comprises suitable logic, code, and/or interfaces, to analyze and decompose the analytical query into one or more specific data processing and analysis operations. This analysis phase is crucial as it transforms a user's business query into a structured sequence of executable operations. The analysis module 218 interprets the query's intent, identifies required analytical components, and determines the necessary sequence of operations that will generate the requested business insights. This transformation from a business query to executable operations forms the foundation for the subsequent workflow generation and agent assignment phases.

In one or more embodiments, analyzing the analytical query by the orchestration engine 216 includes parsing the natural language content using Natural Language Processing (NLP) techniques. The system 102 supports free-form business queries such as “What were the top 10 best-selling products in Q2 of 2024?” or “How has customer satisfaction changed in the last six months?” The orchestration engine 216 systematically decomposes these queries into structured components, specifically:
Key business entities (e.g., products, sales, customers) that indicate required data domains
Temporal parameters and quantifiers (e.g., “Q2 of 2024”, “last six months”) that define analysis boundaries
Analytical operators (e.g., “top-selling,” “changed”) that determine required computational operations
   This structured decomposition provides the foundation for subsequent operation identification and workflow planning.

In one or more embodiments, analyzing the analytical query by the orchestration engine 216 includes analyzing the analytical query by the orchestration engine 216 includes identifying required data elements and analytical objectives. After parsing the query, the orchestration engine 216 performs systematic analysis to:
Map business entities to specific data elements:
   Identify primary data sources (e.g., product sales database, customer feedback repository)
   Determine required data attributes (e.g., sales volume metrics, satisfaction scores)
   Define data granularity requirements (e.g., product-level sales, daily satisfaction ratings)
Extract analytical objectives that determine processing requirements:
   Identify primary analysis type (e.g., ranking, trending, forecasting)
   Determine computational requirements (e.g., aggregation, statistical analysis)
   Define output format specifications (e.g., sorted lists, trend graphs)

For example, for the query “What were the top 10 best-selling products in Q2 of 2024?”, the orchestration engine 216:
Identifies data elements: product master data, transaction records, sales metrics
Maps time period to specific date range: Q2 2024 calendar boundaries
Determines analysis objectives: sales volume calculation, product-wise aggregation, top 10 ranking.

Whereas, for the query, “How has customer satisfaction changed in the last six months?”, the orchestration engine 216:
Identifies data elements: customer feedback data, satisfaction metrics, temporal markers
Maps time period: rolling six-month window from current date
Determines analysis objectives: temporal aggregation, trend calculation, period-over-period comparison.

In one or more embodiments, analyzing the analytical query by the orchestration engine 216 includes determining data dependencies and processing requirements. Once the data elements and objectives are identified, the orchestration engine 216 determines the data dependencies and processing requirements. This involves understanding how data from various sources and processes interact with each other, and how they must be manipulated to answer the query. For example:
For a product sales analysis query, the orchestration engine 216 identifies dependencies such as: product master data must be processed before sales transactions, time period filtering (Q2 2024) must precede aggregation, and ranking computation requires completed aggregation results.
Whereas for a trend analysis queries, the orchestration engine 216 identifies dependencies between time-series data points, ensuring proper sequence of operations from monthly satisfaction score calculation to trend analysis and period-over-period comparison.

In one or more embodiments, analyzing the analytical query by the orchestration engine 216 includes mapping the analytical objectives to the one or more data processing and analysis operations. Based on the identified data elements and dependencies, the orchestration engine 216 determines specific operations needed to generate the required business insights. For example:
For a product ranking objective, the operations may include: extracting raw sales data from enterprise databases, performing data aggregation operations to calculate product-wise sales volumes, and executing sorting operations to generate ranked results.
Whereas for a trend analysis objective, the operations may include: extracting time-stamped customer satisfaction data, applying data transformation operations to standardize metrics, and performing statistical calculations to identify temporal patterns.

In one or more embodiments, the orchestration engine 216, by utilizing the workflow module 220 which may comprise suitable logic, code, and/or interface, generates a computational workflow including a sequence of the one or more data processing and analysis operations. The computational workflow specifies both the sequence and dependencies of operations that need to be executed to transform the raw enterprise data into the requested business insights. For example, a workflow might specify that data extraction operations must be completed before transformation operations begin, or that multiple data analysis operations can be executed in parallel when there are no dependencies between them.

In one or more embodiments, generating the computational workflow within the orchestration engine 216 includes several key tasks to ensure that data processing and analysis operations are executed in an efficient, structured, and error-free manner. The process includes determining the sequence of operations, allowing for parallel processing where feasible, and establishing validation checkpoints to ensure data integrity and accuracy at each stage.

In one or more embodiments, the workflow module 220 may be configured to identify dependencies between data elements and operations. Certain analysis tasks may depend on others. For example, statistical analysis may need to occur after data transformation to ensure accuracy. Thus, the workflow module 220 may be configured to determine the logical order in which operations should be executed, ensuring that each step builds upon the results of the previous one. For operations that depend on specific datasets or analysis results, the workflow module 220 may be configured to ensure that the required data is available before those tasks are executed.

In one or more embodiments, in order to generate the computational workflow, the workflow module 220 may be configured to create execution paths for parallel processing. Where the enterprise data dependencies permit, the workflow module 220 may be configured to generate execution paths for parallel processing. This is particularly useful for improving performance and efficiency in data analysis workflows.

In one or more embodiments, in order to generate the computational workflow, the workflow module 220 may be configured to establish validation checkpoints to ensure data integrity and accuracy at each stage. Accordingly, after each data processing or transformation operation, the workflow module 220 may be configured to check the quality of the data, ensuring that it meets predefined criteria (e.g., no missing values, correct formats). After analysis, the orchestration engine 216 may be configured to validate the intermediate results to ensure they align with expectations and do not introduce errors into the process. If any discrepancies or issues are detected at a checkpoint, the orchestration engine 216 may be configured to flag them, alerting the system 102 to halt or reprocess steps as necessary.

In one or more embodiments, the workflow module 220 may be configured to assigns the one or more data processing and analysis operations to one or more of the worker agents based on specific operation requirements.

In one or more embodiments, the workflow module 220, in order to assign the one or more data processing and analysis operations, may be configured to identify types of data processing and analysis operations for the workflow. The operations can vary widely depending on the query's objectives and the nature of the data being processed. Common types of operations include data extraction, data transformation, data modelling and analysis, data visualization, and report generation.

In one or more embodiments, the workflow module 220, in order to assign the one or more data processing and analysis operations, matches each operation with a corresponding worker agent based on the worker agent's configured capabilities. Each worker agent in the multi-agent framework 208 has a set of configured capabilities that define which types of operations it can handle effectively. The data engineer agent 210 is configured for data preparation operations, and thus is matched with operations like data extraction from enterprise sources, data transformation, validation, and ensuring consistency across various sources. The data scientist agent 212 is configured for analytical modeling operations, and thus is matched with operations involving predictive modeling, statistical analysis, clustering, pattern recognition, and forecasting calculations. The data analyst agent 214 is configured for insight generation operations, and thus is matched with tasks involving the extraction of business insights, generation of visualizations, and compilation of analytical reports based on the processed data.

In one or more embodiments, the workflow module 220, in order to assign the one or more data processing and analysis operations, may be configured to incorporate the matched operations into the workflow sequence. The workflow module 220 may be configured to determine the order in which operations should be executed based on their dependencies. For example, data extraction and transformation operations must be completed before applying analytical models, and model results must be processed and analyzed before generating final business insights.

In one or more embodiments, the workflow module 220 may be configured to optimize execution by identifying operations that can be performed concurrently. For operations without dependencies, the workflow module 220 may be configured to enable parallel execution by assigning them to different worker agents simultaneously. For example, multiple data extraction operations from independent data sources can be executed concurrently. For operations with dependencies, such as data transformation followed by model application, the workflow module 220 may be configured to ensure sequential execution to maintain data integrity and analytical accuracy throughout the workflow.

The execution module 222 may comprise suitable logic, code, and/or interface that may be configured to coordinate sequential execution of the one or more data processing and analysis operations according to workflow dependencies.

In one or more embodiments, the execution module 222 may be configured to continuously monitor the progress of assigned data processing and analysis operations, tracking the status of each operation to ensure timely completion. This monitoring enables the execution module 222 to identify potential execution bottlenecks and initiate corrective actions. For instance, if a worker agent encounters an execution delay or failure, the execution module 222 may be configured to initiate retry mechanisms or trigger error handling procedures, ensuring minimal disruption to the workflow execution.

Additionally, the execution module 222 may be configured to manage the data flow between worker agents. As different operations often depend on intermediate outputs generated by preceding tasks, the execution module 222 ensures that processed data is seamlessly transferred to subsequent worker agents. The data management involves validating the integrity of the transferred data, ensuring compatibility between operations, and maintaining adherence to data dependency requirements.

In one or more embodiments, the execution module 222 is also equipped to handle exceptions that may arise during execution, which includes managing errors such as missing data, incompatible formats, or unexpected processing failures. Upon detecting an exception, the execution module 222 can initiate predefined recovery mechanisms, such as retrying the operation, notifying relevant systems or users, or dynamically modifying the workflow to bypass or correct the issue.

In one or more embodiments, the execution module 222 may be configured to maintain detailed execution logs for audit purposes. The logs record information such as the sequence of executed operations, data flow paths, encountered errors, and resolution steps. By preserving this information, the execution module 222 may be configured to facilitate transparency, traceability, and accountability in the workflow, allowing organizations to review and validate the processing steps that led to the generation of business insights. The logs also provide valuable inputs for improving future workflows and debugging potential issues.

In one or more embodiments, post successful completion of the workflow execution, the generated business insights along with the supported data elements in accordance with configuration made in the system 102, are presented to the user through the UI 104.

The UI 104 is designed to deliver these insights in an intuitive and interactive manner, catering to the diverse needs of users. Insights may be presented in various formats, including textual summaries, interactive dashboards, charts, graphs, and tables, depending on the nature of the analytical query and the user's preferences. For example, trend analyses may be displayed as line graphs, while cluster distributions may appear as scatter plots or heatmaps. Key performance indicators (KPIs) or specific metrics requested by the user may be highlighted prominently to draw attention to critical data points.

In some non-limiting embodiments, in addition to static presentation formats, the UI 104 may also provide interactive features, allowing users to drill down into the insights for more granular details. For instance, users can filter data by categories, explore relationships between variables, or simulate scenarios based on the provided insights.

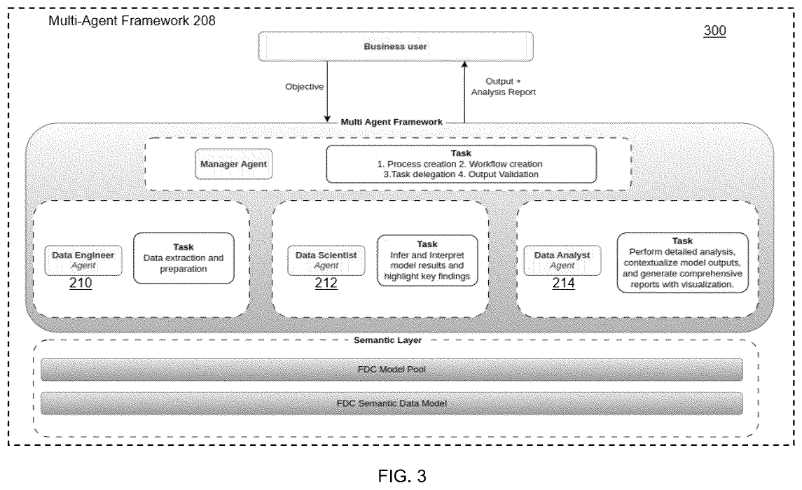

FIG. 3 is an exemplary diagram 300 that illustrates the multi-agent framework 208 of the system 102 for processing the analytical queries to generate business insights, in accordance with an embodiment of the disclosure.

The system 102 processes business queries end-to-end through its multi-agent framework 208, transforming analytical questions into actionable business insights. The process initiates when a business user 302 submits both an analytical query and its associated business objective via the UI 104. For example, a retail manager might submit a query “What are the projected sales for our top-performing products in the next quarter across all regions?” with the business objective of obtaining data-driven sales forecasts to optimize inventory planning decisions.

Upon receiving the query, the orchestration engine 216 initiates the workflow by analyzing the query. The orchestration engine 216 first parses the natural language input to identify key elements such as the required data types (sales data, product categories, regions), the analytical requirements (forecasting), and any specific constraints (top-performing products). The orchestration engine 216 then leverages the semantic processing layer to map these elements to enterprise data sources and determine relationships between data elements. Based on this analysis, it generates a computational workflow that outlines the sequence of data processing and analysis operations needed to fulfill the query, establishing operation dependencies and preparing for worker agent assignment.

As shown in FIG. 3, the data engineer agent 210 is tasked with extracting relevant enterprise data required for the analysis. In this scenario, it connects to enterprise data sources, such as sales databases, inventory logs, and customer interaction records, to retrieve the necessary datasets. It performs data transformation operations to standardize formats, cleanse the data by removing inconsistencies or duplicates, and enrich it with additional context, such as associating sales figures with regional demographics. The data engineer agent 210 validates data quality against predefined rules, ensuring completeness, accuracy, and consistency. Additionally, it maintains data lineage, documenting the origin and transformations applied to the data to support transparency and traceability.

In one or more embodiments, the data engineer agent 210 takes the first task in the workflow: preparing the data.

Extracting Input Data: The data engineer agent 210 connects to enterprise data sources, such as a sales database and inventory management system, and retrieves data relevant to the query. For instance:
Sales transactions for the past year.
Product metadata (e.g., categories, pricing).
Regional sales records.

Transforming Data: The agent processes raw data into a standardized format:
Converts dates to a uniform format.
Merges sales data with product and regional details.
Handles missing or duplicate entries to ensure data integrity.

Validating Input: The agent checks for:
Completeness: Ensuring all top-performing products are included.
Consistency: Verifying that regional data aligns with product records.
Quality: Flagging anomalies, such as unusually high or low sales figures.

Output: A clean, structured dataset ready for analysis, containing historical sales trends segmented by product and region.

Once the transformed data is ready, the data scientist agent 212 initiates the analytical phase of the workflow. It selects the appropriate machine learning models for forecasting based on the characteristics of the data and the analytical objectives. For instance, it might use time-series forecasting models or ensemble methods to predict future sales trends. The data scientist agent 212 preprocesses the data further, if necessary (e.g., normalizing data or creating time-based features), applies the chosen model, and tunes its parameters for optimal performance. Once the model generates predictions, the data scientist agent 212 interprets the results, identifying key drivers of sales trends, such as seasonal patterns or promotional impacts, and prepares the outputs for downstream consumption.

In one or more embodiments, the data scientist agent 212 receives the transformed dataset and processes it to generate forecasts:

Input Analysis: The agent examines the dataset to identify relevant features:
Time-series sales data for forecasting.
Product performance rankings to isolate top performers.
Regional patterns for localized predictions.

Model Selection: Based on the data characteristics, the agent selects a time-series forecasting model, such as ARIMA or an LSTM neural network.

Data Preparation for Modeling:
Creates quarterly aggregations of sales data.
Normalizes sales figures to eliminate scale biases.
Encodes categorical variables, such as product categories or regions.

Model Application and Tuning: The agent applies the model and fine-tunes its parameters to enhance accuracy.
For instance, it adjusts the training window size or regularization parameters.

Output: A set of forecasts indicating projected sales for each top-performing product across all regions for the next quarter.

The data analyst agent 214 processes the outputs generated by the data scientist agent 212 to create actionable insights. It performs statistical analysis to validate the robustness of the predictions, such as checking confidence intervals or error margins. The data analyst agent 214 generates interactive data visualizations, such as line charts for sales trends, bar graphs for product performance, and heatmaps for regional analysis. It also identifies significant patterns, such as regions with declining sales or products with untapped growth potential. Finally, the data analyst agent 214 compiles a comprehensive analytical report, summarizing the findings and providing recommendations, such as increasing stock levels for specific products in high-growth regions.

In one or more embodiments, the data analyst agent 214 receives the model's outputs and generates actionable insights:

Statistical Validation: The data analyst agent 214 verifies:
Forecast reliability by analyzing confidence intervals.
Consistency of projections with historical trends.

Pattern and Trend Identification:
Highlights key insights, such as expected growth regions or products likely to outperform others.
Flags potential risks, such as declining trends in specific regions.

The insights are then returned to the orchestration engine 216, which ensures they align with the user's 302 original query and objectives. These insights are presented to the user 302 via the UI 104 in an intuitive and interactive manner. For example, the retail manager can view a dashboard summarizing sales forecasts by region and product category, with options to drill down into individual metrics or simulate “what-if” scenarios, such as adjusting promotional budgets.

### Exemplary Output

Dashboard Title: Projected Sales Analysis for Top-Performing Products
Query Date: Nov. 20, 2024
Forecast Period: January 2025-March 2025

### Summary Insights

Total Projected Sales: $15.2M
Top-Performing Regions:
   North America: $6.3M
   Europe: $4.5M
   Top Products:
   Product A: $3.1M (North America—$1.8M, Europe—$0.9M)
   Product B: $2.7M (APAC—$1.2M, North America—$0.8M)

### Key Observations and Recommendations

Observation: Product A and B remain the top performers, contributing 40% of total projected sales.
Recommendation: Increase inventory for Product A in North America and Europe to meet demand.
Observation: APAC shows the highest growth rate (10.2%).
Recommendation: Expand distribution networks in APAC for Product B.

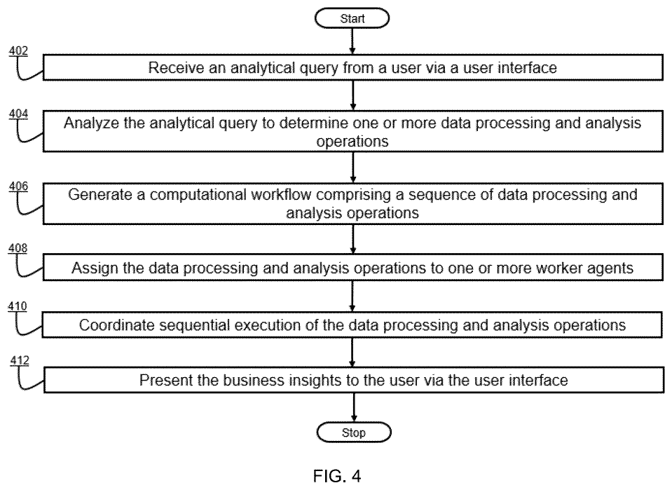

FIG. 4 is a diagram that illustrates a flow chart 400 for a method for processing analytical queries to extract business insights and support decision-making from enterprise data, in accordance with an embodiment of the disclosure.

At 402, an analytical query is received from the user via the UI 104. The UI 104 is also designed to receive inputs of various types, allowing for flexible and adaptable user interactions.

At 404, the orchestration engine 216 analyzes the analytical query to determine one or more data processing and analysis operations. The orchestration engine 216 utilizes the semantic processing layer to perform tasks such as, interpret the analytical query, identify relevant data sources and relationships, and select appropriate machine learning models for analysis.

In one or more embodiments, when an analytical query is received, the orchestration engine 216 relies on the semantic processing layer to interpret the query accurately. Using natural language processing (NLP) models and domain-specific semantic data models, the query is broken down into its key components, such as intent, entities, and metrics. For example, if the query is “Show the monthly revenue trends for Region A,” the semantic layer identifies the focus on “monthly revenue trends” and contextualizes it with “Region A” to guide subsequent operations.

In one or more embodiments, the semantic processing layer, with its domain-specific data models, enables the orchestration engine 216 to determine which data sources contain the information needed to fulfill the query. It maps relationships between enterprise entities, such as linking sales data to regional performance metrics or customer interactions to purchasing trends. By understanding these relationships, the engine ensures that data extraction is targeted and efficient, avoiding irrelevant or redundant information.

In one or more embodiments, based on the nature of the query and the contextual insights provided by the semantic layer, the orchestration engine 216 dynamically selects suitable machine learning models for analysis. For instance, if the query requires forecasting, prediction models are chosen; if it involves segmentation, clustering models are employed; or, if a query demands anomaly detection, relevant diagnostic models are utilized. The semantic processing layer ensures that the models selected align with the domain-specific context and data structure, optimizing the accuracy and relevance of the analysis.

At 406, the orchestration engine 216 generates a computational workflow comprising a sequence of the one or more data processing and analysis operations to extract business insights.

In one or more embodiments, the orchestration engine 216, by utilizing the workflow module 220 that generates a computational workflow comprising a sequence of the one or more data processing and analysis operations to extract business insights.

In one or more embodiments, generating the computational workflow within the orchestration engine 216 comprises several key tasks to ensure that data processing and analysis operations are executed in an efficient, structured, and error-free manner. The process includes determining the sequence of operations, allowing for parallel processing where feasible, and establishing validation checkpoints to ensure data integrity and accuracy at each stage.

In one or more embodiments, the workflow module 220 identifies dependencies between data elements and operations. Certain analysis tasks may depend on others. For example, statistical analysis may need to occur after data transformation to ensure accuracy. Thus, the workflow module 220 determines the logical order in which operations should be executed, ensuring that each step builds upon the results of the previous one. For operations that depend on specific datasets or analysis results, the workflow module 220 ensures that the required data is available before those tasks are executed.

In one or more embodiments, in order to generate the computational workflow, the workflow module 220 creates execution paths for parallel processing. Where the enterprise data dependencies permit, the workflow module 220 generates execution paths for parallel processing.

In one or more embodiments, in order to generate the computational workflow, the workflow module 220 establishes validation checkpoints to ensure data integrity and accuracy at each stage. Accordingly, after each data processing or transformation operation, the workflow module 220 checks the quality of the data, ensuring that it meets predefined criteria (e.g., no missing values, correct formats). After major analysis steps (e.g., after running a machine learning model or performing aggregation), the orchestration engine 216 validates the intermediate results to ensure they align with expectations and do not introduce errors into the process. If any discrepancies or issues are detected at a checkpoint, the orchestration engine 216 can flag them, alerting the system 102 to halt or reprocess steps as necessary.

At 408, the orchestration engine 216 by utilizing the workflow module 220 assigns the one or more data processing and analysis operations to one or more worker agents from a plurality of worker agents based on specific operation requirements. The plurality of worker agents comprise the data engineer agent 210 configured to extract and transform enterprise data, the data scientist agent 212 configured to apply analytical models to transformed data, and the data analyst agent 214 configured to generate analytical insights.

In one or more embodiments, the workflow module 220, in order to assign the one or more data processing and analysis operations, identifies types of data processing and analysis operations for the workflow. The operations can vary widely depending on the query's objectives and the nature of the data being processed. Common types of operations include data extraction, data transformation, data modelling and analysis, data visualization, and report generation.

In one or more embodiments, the workflow module 220, in order to assign the one or more data processing and analysis operations, matches each data processing and analysis operation with a corresponding worker agent based on the worker agent's configured capabilities. Each worker agent in the system 102 has a set of configured capabilities that define which types of tasks it can handle effectively. The matching process involves the data engineer agent (208), which is best suited for data extraction, transformation, and validation tasks. The workflow module 220 matches it with operations like cleaning, merging datasets, or ensuring data consistency across various sources. The matching process involves the data scientist agent 212, which is specialized in applying advanced analytical models, such as machine learning or statistical techniques. It is matched with operations involving predictive modeling, clustering, forecasting, or any task that requires complex data analysis. The matching process involves the data analyst agent 214, which is responsible for data analysis, report generation, and visualization. It is matched with tasks involving the generation of insights, visualizations, and interactive reports based on the processed data.

In one or more embodiments, the workflow module 220, in order to assign the one or more data processing and analysis operations, incorporates the matched data processing and analysis operations into the workflow sequence. The workflow module 220 determines the order in which operations should be executed based on their dependencies. For example, data extraction and transformation must occur before the application of analytical models, and model results must be analyzed and visualized before generating a final report.

In one or more embodiments, for operations that can run in parallel, the workflow module 220 assigns them to the relevant worker agents simultaneously to optimize efficiency and reduce overall processing time. For example, if data extraction from multiple sources is independent, these tasks can be assigned to different agents concurrently. For operations that must run sequentially (e.g., data cleaning followed by modeling), the workflow module 220 ensures that each task is performed in the correct order, respecting task dependencies to ensure the integrity and accuracy of the results.

At 410, the orchestration engine 216 by utilizing the execution module 222, coordinates sequential execution of the one or more data processing and analysis operations according to workflow dependencies.

In one or more embodiment, the execution module 222 continuously monitors the progress of assigned data processing and analysis operations, tracking the status of each task to ensure timely completion. The monitoring allows the execution module 222 to identify any potential delays or bottlenecks in the execution process and take corrective actions when necessary. For instance, if a worker agent encounters an unexpected delay or failure, the module can reassign tasks, trigger retries, or escalate issues for resolution, ensuring minimal disruption to the overall workflow.

Additionally, the execution module 222 manages the data flow between worker agents. As different operations often depend on intermediate outputs generated by preceding tasks, the execution module 222 ensures that processed data is seamlessly transferred to subsequent worker agents. This data management involves validating the integrity of the transferred data, ensuring compatibility between operations, and maintaining adherence to data dependency requirements.

In one or more embodiments, the execution module 222 is also equipped to handle exceptions that may arise during execution, which includes managing errors such as missing data, incompatible formats, or unexpected processing failures. Upon detecting an exception, the execution module 222 can initiate predefined recovery mechanisms, such as retrying the operation, notifying relevant systems or users, or dynamically modifying the workflow to bypass or correct the issue.

At 412, the system 102 presents the business insights to the user via the UI 104. In an embodiment, the system 102 may be configured to share the supported data elements along with the generated business insights in accordance with configuration made in the system 102

The UI 104 is designed to deliver these insights in an intuitive and interactive manner, catering to the diverse needs of users. Insights may be presented in various formats, including textual summaries, interactive dashboards, charts, graphs, and tables, depending on the nature of the analytical query and the user's preferences. For example, trend analyses may be displayed as line graphs, while cluster distributions may appear as scatter plots or heatmaps. Key performance indicators (KPIs) or specific metrics requested by the user may be highlighted prominently to draw attention to critical data points.

The method and system offers a significant advantage by addressing the challenges of inefficient decision-making through the integration of an advanced orchestration layer. This layer leverages the reasoning capabilities of a large language model (LLM), a diverse pool of machine learning (ML) models, a robust semantic data model, and a reliable underlying data foundation layer. The LLM acts as the cognitive engine, interpreting complex analytical queries with human-like reasoning, while the ML models, either provided by the system or integrated from customer assets, execute specific analytical tasks such as predictions, classifications, and clustering with precision.

A significant strength of the system lies in the semantic data model, which establishes meaningful relationships between enterprise attributes and key performance indicators (KPIs). This semantic layer enhances the system's ability to understand and contextualize business entities and objectives, ensuring that insights generated are not only accurate but also relevant to the decision-maker's goals. Moreover, the data foundation layer serves as a single source of truth, providing clean, up-to-date, and trustworthy data that eliminates errors and inconsistencies in the analytical process.

Moreover, the multi-agent framework integrated into the proposed system and method provides a transformative advantage by enabling a modular, scalable, and intelligent approach to solving complex analytical challenges. By leveraging an orchestration layer built on this framework, the system distributes and manages tasks efficiently across specialized agents, each tailored for distinct data processing and analysis operations.

In addition, the inclusion of LLM within the multi-agent framework adds a layer of cognitive reasoning and natural language understanding, allowing the system to interpret user queries with greater accuracy and contextual awareness. The collaboration between the LLM, multiple ML models either preconfigured by the system or provided by customers and a robust semantic data model enables the system to deliver nuanced insights tailored to specific business needs.

This multi-agent framework not only optimizes resource utilization by assigning tasks to agents with specific capabilities but also ensures adaptability through its ability to integrate customer-provided ML models seamlessly. The semantic data model further enhances the system by providing a structured understanding of enterprise attributes and KPIs, enabling precise and relevant insight generation. Together, these components form a cohesive system that empowers businesses to make data-driven decisions with speed, accuracy, and scalability, addressing modern analytical challenges effectively.

The method and system is also advantageous in that by equipping with the knowledge derived from the system's advanced analytics and the skills to interpret these insights, users are empowered to make informed decisions and take decisive actions to achieve their objectives. The system's multi-agent framework, in tandem with the orchestration layer powered by LLM, ML models, and a semantic data model, provides not only accurate and contextually relevant insights but also the reasoning behind them. This clarity allows decision-makers to understand the implications of various data points, enabling them to evaluate options effectively.

By presenting actionable insights aligned with specific business objectives, the system supports users in bridging the gap between data analysis and strategic execution. Armed with this knowledge and their expertise, humans can confidently decide on the best course of action whether it involves adjusting strategies, reallocating resources, or initiating corrective measures to achieve desired outcomes efficiently and effectively.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for processing analytical queries to extract business insights from enterprise data, comprising:
a processor;
a memory storing instructions that, when executed by the processor, cause the system to implement:
a multi-agent framework comprising:
a plurality of worker agents, wherein each worker agent is configured to execute one or more data processing and analysis operations on enterprise data, the plurality of worker agents comprise at least a data engineer agent configured to extract and transform enterprise data, a data scientist agent configured to apply analytical models to transformed data, and a data analyst agent configured to generate analytical insights;
an orchestration engine operatively coupled to the plurality of worker agents, wherein the orchestration engine is configured to:
receive, via a user interface, an analytical query from a user;
analyze the analytical query to determine one or more data processing and analysis operations;
generate a computational workflow comprising a sequence of the one or more data processing and analysis operations to extract business insights;
assign the one or more data processing and analysis operations to one or more of the worker agents based on specific operation requirements;
coordinate sequential execution of the one or more data processing and analysis operations according to workflow dependencies; and
present the business insights generated from the execution of the one or more data processing and analysis operations, via the user interface, to the user.

2. The system of claim 1, wherein analyzing the analytical query comprises:
parsing natural language content of the analytical query;
identifying required data elements and analytical objectives;
determining data dependencies and processing requirements; and
mapping the analytical objectives to the one or more data processing and analysis operations required for extracting business insights.

3. The system of claim 1, wherein the multi-agent framework further comprises: a semantic processing layer operatively coupled to the orchestration engine, the semantic processing layer comprising:
domain-specific semantic data models defining relationships between enterprise entities for business insight extraction; and
trained machine learning models configured for enterprise data analysis tasks, wherein the orchestration engine utilizes the semantic layer to interpret the analytical query, identify relevant data sources and relationships, and select appropriate machine learning models for analysis.

4. The system of claim 3, wherein the trained machine learning models comprise classification models for categorizing enterprise data, prediction models for forecasting business metrics, clustering models for pattern identification, and natural language processing models for query interpretation.

5. The system of claim 1, wherein generating the computational workflow comprises:
determining an order of the one or more data processing and analysis operations based on enterprise data dependencies and insight generation requirements;
creating execution paths for parallel processing where the enterprise data dependencies allow; and
establishing checkpoints for validation between sequential operations.

6. The system of claim 1, wherein the data engineer agent is configured to:
extract data from multiple enterprise data sources;
perform data transformation operations to standardize data formats;
validate data quality based on predefined rules; and
maintain data lineage throughout processing operations.

7. The system of claim 1, wherein the data scientist agent is configured to:
select appropriate analytical models based on data characteristics;
apply the selected models to the transformed data;
tune model parameters for optimal performance; and
interpret model outputs for further analysis.

8. The system of claim 1, wherein the data analyst agent is configured to:
perform statistical analysis on processed data;
generate interactive data visualizations;
identify key patterns and trends; and
create comprehensive analytical reports.

9. The system of claim 1, wherein assigning the one or more data processing and analysis operations comprises:
identifying types of data processing and analysis operations for the workflow;
matching each data processing and analysis operation with a corresponding worker agent based on the worker agent's configured capabilities; and
incorporating the matched data processing and analysis operations into the workflow sequence.

10. The system of claim 1, wherein each worker agent can be instantiated multiple times within the workflow based on the specific operation requirements and different instances of a same worker agent can execute different data processing and analysis operations concurrently within the workflow.

11. The system of claim 1, wherein coordinating execution comprises:
monitoring progress of assigned data processing and analysis operations;
managing data flow between worker agents;
handling exceptions during execution; and
maintaining execution logs for audit purposes.

12. A computer-implemented method for processing analytical queries to extract business insights from enterprise data, comprising:
receiving, via a user interface, an analytical query from a user;
analyzing, via an orchestration engine, the analytical query to determine one or more data processing and analysis operations;
generating, via the orchestration engine, a computational workflow comprising a sequence of the one or more data processing and analysis operations to extract business insights;
assigning, via the orchestration engine, the one or more data processing and analysis operations to one or more worker agents from a plurality of worker agents based on specific operation requirements, wherein the plurality of worker agents comprise at least a data engineer agent configured to extract and transform enterprise data, a data scientist agent configured to apply analytical models to transformed data, and a data analyst agent configured to generate analytical insights;
coordinating, via the orchestration engine, sequential execution of the one or more data processing and analysis operations according to workflow dependencies; and
presenting the business insights generated from the execution of the one or more data processing and analysis operations, via the user interface, to the user.

13. The method of claim 12, wherein analyzing the analytical query comprises:
parsing natural language content of the analytical query;
identifying required data elements and analytical objectives;
determining data dependencies and processing requirements; and
mapping the analytical objectives to the one or more data processing and analysis operations required for extracting business insights.

14. The method of claim 12, further comprising utilizing, by the orchestration engine, a semantic processing layer to:
interpret the analytical query using domain-specific semantic data models;
identify relevant data sources and relationships; and
select appropriate machine learning models for analysis.

15. The method of claim 12, wherein generating the computational workflow comprises:
determining an order of the one or more data processing and analysis operations based on enterprise data dependencies and insight generation requirements;
creating execution paths for parallel processing where the enterprise data dependencies allow; and
establishing checkpoints for validation between sequential operations.

16. The method of claim 12, wherein assigning the one or more data processing and analysis operations comprises:
identifying types of data processing and analysis operations for the workflow;
matching each data processing and analysis operation with a corresponding worker agent based on the worker agent's configured capabilities; and
incorporating the matched data processing and analysis operations into the workflow sequence.

17. The method of claim 12, wherein coordinating execution comprises:
monitoring progress of assigned data processing and analysis operations;
managing data flow between worker agents;
handling exceptions during execution; and
maintaining execution logs for audit purposes.
